(19) United States
(12) Patent Application Publication
(10) Pub. No.: US 2026/0019473 A1
(43) Pub. Date: Jan. 15, 2026

(54) MULTI-PROTOCOL ADAPTOR WIRELESS COMMUNICATIONS DEVICE FOR ENERGY MANAGEMENT

(71) Applicant: Budderfly, Inc., Shelton, CT (US)

(72) Inventors: Jacob Marchinus Boerma, Orange, CT (US); Christina D. Sipes, Cincinnati, OH (US); Ali Olleik, Bourj Brajne (LB); Eddy Abdo Ghanime, Beirut (LB)

(21) Appl. No.: 19/216,488

(22) Filed: May 22, 2025

Related U.S. Application Data
(60) Provisional application No. 63/669,748, filed on Jul. 11, 2024.

(51) Int. Cl. H04L 69/18; H04L 67/55

(52) U.S. Cl. CPC H04L 69/18; H04L 67/55

(57) ABSTRACT

A weatherproof multi-protocol adaptor is presented which acts as a Modbus master communicating with one or more Modbus slaves over RS485. Data can subsequently be transmitted wirelessly over Wi-Fi or LoRaWAN or through a physical ethernet port to a local facilities controller without the encumbrances of drilling holes and running wires to connect equipment in hard-to-reach places.

### CROSS-REFERENCE TO RELATED APPLICATIONS

This application claims the benefit of U.S. Provisional Application Ser. No. 63/669,748, filed Jul. 11, 2024, the complete disclosure of which is incorporated herein by reference.

### TECHNICAL FIELD

The present disclosure relates to a multi-interface/multi-protocol wireless adaptor is presented allowing wireless deployment of traditionally wired connections thereby removing obstacles of installation such as drilling holes and running wires and in some aspects is particularly useful for the installation and commissioning of heating/cooling and other energy systems equipment.

### BACKGROUND

Rising energy costs and a growing desire to reduce environmental impacts have resulted in facilities updating their systems to more energy efficient equipment.

Equipment is becoming increasingly intelligent and adaptable allowing for a multitude of sensors to be connected, and configuration settings to be controlled and adjusted in order to make systems more energy efficient.

To improve energy efficiency, a facilities controller is increasingly used to manage the equipment at a particular site tying together sensors and equipment and using it's more holistic view to further improve energy efficiency.

One of the largest consumers of energy on most sites is the HVAC (Heating Ventilation and Air Conditioning) unit. This unit is often mounted as an RTU (roof top unit) or placed on the outside of the facility, thus removed from other control equipment and network connectivity equipment within the premises and making it difficult to wire up and connect to a facilities controller.

Further, facilities controllers are often connected to a central management system which can bring in variables such as billing information, external feeds like weather and events. Some can even use historical data of similar sites for estimation and control purposes. The systems may utilize occupancy and Co2 data obtained through sensors in the determination of ventilation requirements and setpoints. These additional inputs allow the systems to manage the HVAC unit to adjust temperature and air quality to meet the needs of the occupants while optimizing energy use.

As another example, refrigeration systems are also large consumers of energy, and these can be controlled to dynamically manage set-points and defrost cycles to avoid energy usage peaks thereby minimize energy costs.

However, the foregoing requires communication between the units and the growing number of sensors and smart devices. In order to manage the system, there needs to be a connection with the device at hand. Traditional interfaces with many refrigeration or HVAC devices consist of Modbus or BACnet wired connections Thus, it is often necessary to run wires to establish a connection.

Some equipment may be difficult to reach and heavy to move rendering the connection and running of wires difficult. Other equipment may be on the outside of the premises, adding further complexity such as requiring drilling through rooftops or walls to establish run wires that can establish communications with a facilities controller or management system within the interior of the premises.

Any such drilling may raise structural concerns or introduce leaks. Further, in multi-tenant dwellings, obtaining permission to drill holes in the room may be difficult if not impossible, thus dashing the hopes of tenants wanting the ability to perform the desired energy saving upgrades.

Even when running wires, there may be a variety and mix of protocols and interfaces present across sensors and equipment. In some cases, adaptors may be available, but in many cases, these also require programming or configuration. These many challenges of interfacing various devices with varying protocols and interfaces must be overcome just to establish the connection with the device at hand.

Until present, there have been attempts to use Wi-Fi devices introduced to the market. However, Wi-Fi is not ideal for many installations as the signal frequencies are not ideal for obtaining coverage because the locations of the transmitters/receivers are often in back-rooms and closets that are often enclosed in concrete, thus providing poor signal quality. Even cellular based systems, while better, are not ideal in these circumstances. In addition, monthly subscription plans add substantially to cost, and peripheral equipment and software to communicate with the wired devices must be added or developed and deployed.

More recently, LoRaWAN (long range wide area network) protocols have emerged which provide excellent penetration through concrete surfaces as well as long range capability for small bandwidth applications. These can work well for industrial telemetry type applications of for limited data gathering and control such as that used for managing energy consuming devices such as HVACs, refrigeration, various sensors, plugs, and the like. Unfortunately, these devices don't typically offer any native LoRaWAN interfaces and are instead incumbered with physical wired connections such as RS485.

U.S. patent Ser. No. 11/881,992 to Dao relates to a general plug and play platform for IoT devices that provides a point to multipoint communication between heterogeneous IoT devices regardless of their types, physical connections, industrial standards, operating parameters, and communication protocols. Dao however does not support getting power over ethernet thus requires wiring or running of power to allow it to work. Dao also does not address the issues of weatherproofing the interface or having it amenable to tight spaces and does not provide a full range of connector/protocols necessary for flexible communications between physical devices such as HVAC devices and their sensors and associated controllers.

U.S. Pat. No. 9,251,699B2 to Greene relates to wireless sensor systems, methods and apparatus with switch and outlet controls. Greene suffers similar deficiencies as compared to Dao.

US patent US20130086195A1 to Hiniker relates to communication within building automation systems, and more particularly to communication between wired and wireless automation devices operating according to different network protocols within a building automation system. Hiniker does not disclose the ability to leverage LoRaWAN systems nor how to harvest power off a PoE Power over ethernet fashion. Hiniker also does not address weatherproofing the interface or having it installed within the confines of tight spaces.

Patent US20150106447A1 to Hague relates to a Modular system and method for communicating information between different protocols on a control network. In a BACnet Internetwork, a modular concept is implemented to permit interchangeable protocol conversion between a host protocol like logic-level BACnet MS/TP and another protocol or function by providing pluggable communications modules that avoid tedious software configuration. While Hague does describe Power over Ethernet, the Hague reference does not disclose the ability to leverage LoRaWAN systems for inbuilding communication nor does it address weatherproofing or miniaturization aspects for tight space deployment or easy attachment.

### SUMMARY OF THE INVENTION

Therefore it is an object of the invention to provide a device that enables communications via several different protocols.

It is a further object of the invention to provide an easy to use and durable communications interface for various devices and their sensors and controllers which is easy to mount and install, in preferred embodiments without requiring permitting or drilling or otherwise opening walls or routing electrical or signal wires.

These and other objects are achieved by providing a communications device which can gather and send data from RS485 based BACnet devices and transport this data over one or more target interfaces, including LoRaWAN or Wi-Fi, or an existing wired Ethernet network or bluetooth. The device includes a weatherproof enclosure with a small footprint allowing installation next to RTU and external HVAC systems in tight footprint spaces.

The communication a device could be deployed outside with a weatherproof housing that can fit in tight spaces and is easily mountable on existing equipment. Quick serve restaurants are often tightly packed with equipment with heavy hard to move equipment that cannot be easily wired up. There is also not a lot of room for delicate or additional equipment to be added, and due to heavy traffic, fumes, and heat any device must necessarily be rugged and weatherproof by design.

In one aspect a system and method provides a multi-protocol adaptor which acts as a gateway allowing communications over multiple protocols and interfaces in an outdoor weatherproof enclosure capable of being mounted into tight spaces.

In one configuration, an interface is provided to communicate with sensors, meters, and actuators or other devices over a standard RS485 Modbus (originally Modicon Bus), BACnet (Building Automation and Control Networks) MS/TP (Master Slave Token Passing) interface.

The described objects of the invention and others are achieved by a device for sending and receiving data and includes an enclosure containing a plurality of communication devices. These communication devices include a long rage wide area network (LoRaWAN) device, an ethernet interface, a building and automation control network (BACnet) device, a Wi-Fi device. A port is provided comprising at least two pin connectors positioned on the enclosure and configured to allow an RS connector to connect to the port to thereby enable communications with the BACnet device. An ethernet port is configured to allow an ethernet connector to connect to the ethernet port to thereby enable communications with the ethernet interface. An antenna for the LoRaWAN and/or the Wi-Fi device is provided. The device is configured such that data received from any one of the plurality of communications devices is transmittable via any other one of the plurality of communications devices.

In certain aspects the port provides for connection to an RS485 connection. In other aspects the data is received over MQTT. In other aspects the data is transmitted over MQTT. In still other aspects enclosure is weather resistant. In yet other aspects the data is received from the port and converted by the device to a wireless signal for transmission via one or more of the communications devices configured to transmit wirelessly. In still other aspects the antenna comprises at least two antennas, a first one of the at least two antennas is connected to the LoRaWAN device and a second one of the at least two antennas is connected to the Wi-Fi device. In still other aspects wherein the port comprises at least four pin connectors, at least two of the pin connectors configured to receive power in order to power the communication devices and at least two of the pin connectors configured to receive data.

Other objects are achieved by providing a device for sending and receiving data including an enclosure containing a controller, a memory and a plurality of communication devices, the plurality of communication devices comprising a first wireless communication device, a second wireless communication device, a first wired communication device and a second wired communication device. The first wireless communication device is configured to operate at a first frequency band. The second wireless communication device is configured to operate at a second frequency band which is different from the first frequency band. A first antenna is positioned outside the enclosure and is configured to connect to first wireless communication device via a first connection which passes through the enclosure. A second antenna is positioned outside the enclosure and is configured to connect to the second wireless communication device via a second connection which passes through the enclosure. A first port and a second port are provided. The first port is associated with the first wired communication device and the second port is associated with the second wired communication device and the controller is configured to receive power via the first or second port. The device is configured such that data received from any one of the plurality of communications devices is transmittable via any other one of the plurality of communications devices.

In certain aspects the first wireless communication device is configured to communicate via LoRaWAN. In other aspects the second wireless communication device is configured to communicate via Wi-Fi. In other aspects the second wireless communication device is configured to communicate via Wi-Fi and the first wired communication device is configured to communicate with a BACnet network and the second wired communication device is configured to communicate via ethernet. In other aspects the enclosure is weather resistant.

Yet other objects are achieved by providing a method of connecting a environment conditioning device to a network comprising one or more steps of: connecting an adaptor to a physical communication port of an environmental conditioning device at a facility; transferring data between the environmental conditioning device and a first computer via the adaptor, the adaptor comprising an enclosure, the enclosure containing a controller, a memory and a plurality of communication devices, the plurality of communication devices comprising a first wireless communication device, a second wireless communication device, a first wired communication device and a second wired communication device; wherein the physical communication port is associated with the first or second wired communication device and the data is transferred between the environmental conditioning device and the first computer via the adaptor using one of: the first wireless communication device, the second wireless communication device or one of the first or second wired communication device which is not associated with the physical communication port.

In certain aspects the data is transferred to the first computer using the first wireless communication device and the first wireless communication device communicates via a long rage wide area network (LoRaWAN). In certain aspects the physical communication port comprises at least two pin connectors. In other aspects the data is transferred to the first computer using the second wired communication device and the second wired communication device comprises an ethernet connection. In yet other aspects connecting the adaptor to the physical communication port of the environmental conditioning device at the facility comprises connecting each of a plurality of adaptors to one of a plurality of the environment conditioning devices via the physical communication port of the associated environmental conditioning device and wherein transferring data between the environmental conditioning device and the first computer comprises transferring the data between the plurality of environmental conditioning devices to the first computer via the associated one of the plurality of adaptors.

While the focus in the descriptions and the examples used herein relate to energy management devices and restaurant specific use cases may be used, similar mechanisms to transport signals from wired devices over wireless could benefit from a similar system regardless of the application. These descriptions are not meant to be limiting.

Other aspects and features will become apparent from consideration of the following description taken in conjunction with the accompanying drawings.

### BRIEF DESCRIPTION OF THE DRAWINGS

The drawings illustrate example embodiments in which:

FIG. 1 Depicts an overview of the components of the multi protocol adapter (MPA).

FIG. 2 Depicts the MPA device of FIG. 1 in operation and the various components involved in the application of the MPA device at an example installation.

FIG. 3 Depicts an exploded view of the multi-protocol adaptor device of FIG. 1.

FIG. 4A. shows a front view of the assembled MPA device of FIGS. 1 and 3.

FIG. 4B shows a rear view of the assembled MPA device of FIGS. 1 and 3.

FIG. 5. Shows a logical diagram of the profile management system for device(s) communicating via the MPA of device.

FIG. 6. Shows a block diagram of the hardware components of the the MPA device of FIGS. 1, 3, 4A and 4B.

### DETAILED DESCRIPTION

Referring now to the drawings, wherein like reference numerals designate corresponding structure throughout the views. The following examples are presented to further illustrate and explain the present invention and should not be taken as limiting in any regard.

LoRa, which stands for Long Range, is a type of LPWAN (Low Power Wide Area Network) communication technology. It is based on a low-power wireless standard developed by Semtech, and its goal is to solve the contradiction between power consumption and transmission distance. Generally speaking, low power consumption means a shorter transmission distance, while high power consumption means a longer transmission distance. By developing LoRa technology, the problem of longer transmission distance than other wireless methods under the same power consumption conditions was solved, thus achieving the unity of low power consumption and long distance.

LPWAN communication technology LPWAN (Low-Power Wide-Area Network) is a wireless network used in the Internet of Things (such as battery-powered sensors) that allows long-distance communication at a low bit rate. The low power requirement, low bit rate, and low usage frequency distinguish LPWAN from wireless wide-area networks, which are designed to connect businesses or users and can transmit more data but consume more energy. The transmission rate of each channel in LPWAN is typically between 0.3 kbit/s and 50 kbit/s.

LoRa has several advantages including (1) Stable network connection: The LoRa technology achieves long-range communication by improving the transmission distance, with communication distances of several kilometers, even up to 10 kilometers or more. This long-range transmission distance along with its sub gigahertz frequency range and modulation allows the LoRa network to penetrate various building materials such as concrete, glass, and metal making it stable and having coverage advantages. (2) Low power consumption. LoRa uses long-range transmission technology, which can achieve long-distance transmission with relatively low power, thereby reducing energy consumption during the transmission process. (3) Good network transmission performance. LoRa uses linear frequency modulation spread spectrum modulation technology, which can maintain the low power consumption characteristic of frequency shift keying (FSK), and also support spreading technology to increase communication distance and improve network anti-jamming and communication ability. (4) Wide coverage and high capacity. It supports processing data from multiple nodes through a gateway/concentrator, and the communication distance can reach more than 15 km (related to the environment). (5) Easy to deploy and low cost. LoRa network works in unlicensed frequency bands, and in terms of operation and deployment, the terminal module cost is minimal.

LoRaWAN is a media access control (MAC) layer protocol maintained by the LoRa Alliance, a non-profit technology alliance. It is designed to allow low-powered devices to communicate with Internet-connected applications over long range wireless connections.

LoRaWAN network architecture is usually divided into (1) the Node Module: responsible for data collection or executing actions; (2) The Gateway Module: the gateway module is divided into two types. The first type only handles data forwarding, similar to a courier transit station. It does not handle unpacking and does not know what kind of goods are inside the courier package. (Our LG1301-PF LoRaWAN belongs to this type). The second type can handle data processing within the gateway. In fact, the second type of module implements a small LoRaWAN server software, which is responsible for managing node modules and data parsing output, input encryption, etc.; (3) the Server: responsible for processing, saving, displaying and other tasks for the data collected by the node module. The principle of the second type of gateway module mentioned above is designed based on the server.

LoRaWAN has a star or star-to-star topology structure, in which nodes can only send data to the gateway, and nodes cannot communicate with each other. The same goes for gateways, which cannot communicate with each other.

LoRa is a physical layer transmission technology (PHY) that allows devices to exchange information. LoRaWAN is a medium access control layer (MAC) protocol but primarily used as a network layer protocol intended for device-to-infrastructure communication, and it manages communication between LoRaWAN gateways and endpoint devices. It adds networking, routing, uplink and downlink scheduling to optimize battery usage, and most importantly, improves security. Overall, LoRaWAN is a technology that uses LoRa modules to set parameters or transmit signals according to certain rules.

LoRa is a physical layer transmission technology with typical characteristics of long distance, low power consumption, and relatively low speed. LoRaWAN is a set of protocol standards based on the MAC layer on top of the LoRa physical layer transmission technology, which is a network technology. LoRaWAN includes LoRaWAN nodes, LoRaWAN gateways, and the LoRaWAN protocol and data cloud platform, there are two interfaces: one is the data interface between the sensor and the gateway to ensure that the data is transmitted to the network; The other is the data interface between the LoRaWAN protocol and data cloud platform and the user's application to transmit network data to the application.

Multiple node modules communicate with a single gateway through send-receive. The gateway has eight independent channels, each corresponding to a specific frequency and can receive all spreading factors (SF). The transmission interval is randomly selected and each packet is sent through a randomly selected channel, significantly reducing the possibility of data collision. Different SFs will not interfere with each other, allowing for the implementation of Automatic Data Rate (ADR) technology.

BACnet is a Data Communication Protocol for Building Automation and Control Networks developed under the auspices of the American Society of Heating, Refrigerating and Air-Conditioning Engineers (ASHRAE). BACnet is an American national standard, a European standard, a national standard in more than 30 countries, and an ISO global standard. The protocol is supported and maintained by ASHRAE Standing Standard Project Committee 135 (SSPC 135).

Data communications protocols such as BACnet are typically divided into protocol layers. BACnet can for instance be split into an upper logical layer, or software—only layer, and a lower physical layer. Controller Devices using BACnet communicate with each other and with host computer nodes using physical communications media (or layers) such as Ethernet or TIA-485-A [5](or EIA-485, or RS-485). For ease of interoperability, the same upper, logical layer can typically be implemented on top of any of the lower physical layers in its family with little, if any, change.

The MPA (Multi-Protocol Adaptor) device acts as a Modbus master whereas the sensors, meters, actuators, or other device will be the Modbus slave. The BACnet MSTP protocol allows the support of multiple masters, and as such the MPA device acts as a master to collect data from the connected slave device.

Multiple slave devices can be connected on a Modbus or BACnet branch and the MPA device acts as a data concentrator for gathering data from the branch. For control, the settings and configuration of the connected slave devices is selected by software through the selection and activation of preset profiles. A library of known configurations is kept by the central management system as device profiles and this library can be used to access and download details needed by the MPA to quickly interface with new devices. This MPA only has to look up and download the profiles that it needs, and the central management system keeps the updated collection. This allows for rapid configuration and addition of new devices to the system.

On the opposite side of the bridge, the system connects to the internet and exposes the data collected from the aforementioned sensors, meters, actuators, or other device providing the data to a facilities controller. In such a configuration, the MPA can connect over Wi-Fi, ethernet or LoRa WAN.

In such a configuration the MPA uses an available Wi-Fi network to connect and deliver the data to the back-end system responsible for data collection and control, generally a facilities controller or an energy management system. Alternatively, the device can connect to a LoRa WAN gateway which in turn relays the data to the back-end system.

In the aforementioned configurations, the device is equipped with separate radio systems and antennae for Wi-Fi and LoRaWAN allowing the MPA device to communicate with both independently. In such configurations the device is powered by an external power source which can supply 5-15 VDC. This can be a 24AC feed from a rooftop RTU unit, or a wall plug, or other with an appropriate adapter.

The device can similarly connect to the internet using physically connected ethernet through a provided RJ45 connector. In such a configuration, the MPA device can draw power using Power over Ethernet (PoE).

Generally speaking, when multiple options are available, connectivity over ethernet is preferred as it can be used with PoE negating the need for a power source or supply. If the physically wired ethernet is not available, the next alternative would be Wi-Fi provided there is strong signal, and the device is within the proximity of an access point. In such cases, there is no need for a LoRaWAN gateway. Where longer range wireless transmission is desired, or when signal from a Wi-Fi is not in proximity or unreliable, LoRaWAN would be preferred.

In one such configuration, the MPA device is coupled with a smart meter over Modbus. The MPA device is able to draw power using PoE from the connection with the smart meter directly. As the meters are wired to the facilities controller and a USB to RS485 converter is used, this facilitates the transmission of data over wireless using the MPA.

In another configuration, the MPA can be used in conjunction with water meters within the premises. In such a configuration, the Modbus interface is used, and the MPA can transmit data over ethernet, benefitting from the PoE functionality.

In another configuration, the MPA device and communicate with the RTU of an HVAC system over RS485 converting the Modbus signals to wireless so that they can be transmitted to a facilities controller without the need for any additional drilling of holes for cabling.

The system is composed of a processor coupled to storage and both a ROM and RAM memory system. The system has a communication system with physical interfaces for Wi-Fi including a radio and antenna and associated circuitry and software to establish Wi-Fi connections. MAC addresses are assigned to the device and are used to distinguish the device on the network.

The system also includes an independent LoRaWAN radio and antenna with associated circuitry and software to establish LoRaWAN connections. Unique keys over LoRaWAN are used to distinguish the device on the network as specified by the LoRaWAN standard.

Further, a physical connector is used to connect physical ethernet connections. Associated circuitry and software are present to establish ethernet connections.

All of the aforementioned interfaces act independently and can be used in unison.

In all such cases, authentication of devices is done using a system of certificates that are factory installed on the devices. While the MPA device allows for the initiation of a connection attempt between the physical device by transporting the signals between the device and the back-end energy management systems or facilities controllers, the certificate authentication must be successfully done in order to establish and maintain a successful connection.

Other security protocols are also facilitated by the use of these certificates, such as the whitelisting or blacklisting of devices. Additional checks such as the validation of firmware via signatures or checksums is in place. Any security failure or anomaly can result in the connection being terminated.

It should be noted that in traditional systems that use MODbus the definition and configuration of these profiles is a time consuming and potentially error prone process. The advantages of the centrally managed quickly accessed profiles brings many benefits to the system in for rapid deployment. Further, the roof top RTU installer is no adept at programming interfaces and getting to the bottom of configuration setting for the setup of these devices. The simple profile-based system allows the installer to both rapidly deploy the system and test functionality without the need for coordination with programmers or data specialists.

In the configurations outlined, the device footprint is purposefully small so as to fit into tight spaces. There are also magnetic attachments so as to avoid cumbersome attachment straps or screws in difficult to reach places. Further, the overall device is sealed in a weatherproof clamshell like case protecting it from the elements. Further, connectors are also weatherproof for signal and power inputs. The design of the system is weather resistant to operate in a range of −40 C to 50 C or (−13 F to 122 F).

While the MPA device is not directly affecting power consumption or reducing energy use, it is key for energy reduction in that it directly enables the deployment of energy conserving devices such as energy meters, water meters, roof-top HVAC units, sensors, and more. It enables these deployments in situations and environments where they would otherwise not be installed due to cost, complexity, or permissions and access issues.

Example embodiments as described herein depict various applications of the MPA device in applications where wireless communication is established and provided for traditionally wired connections.

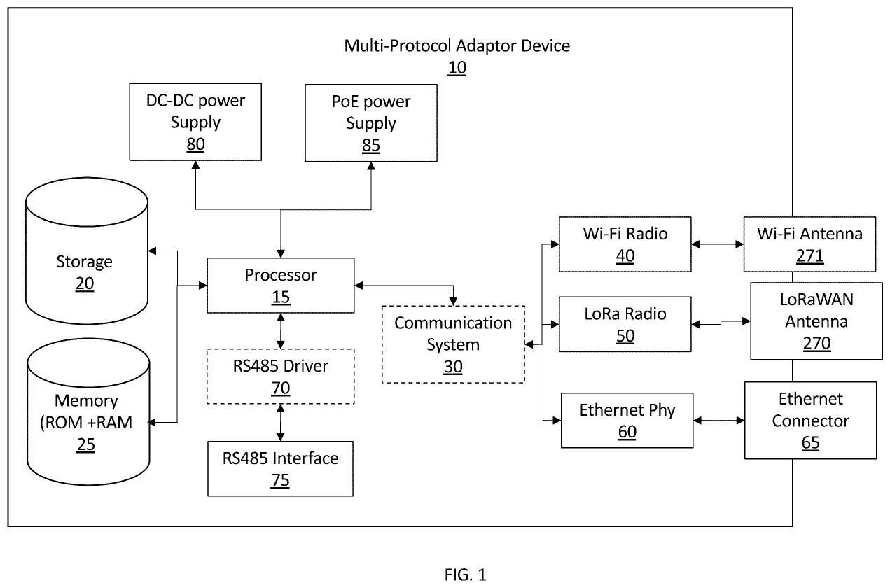

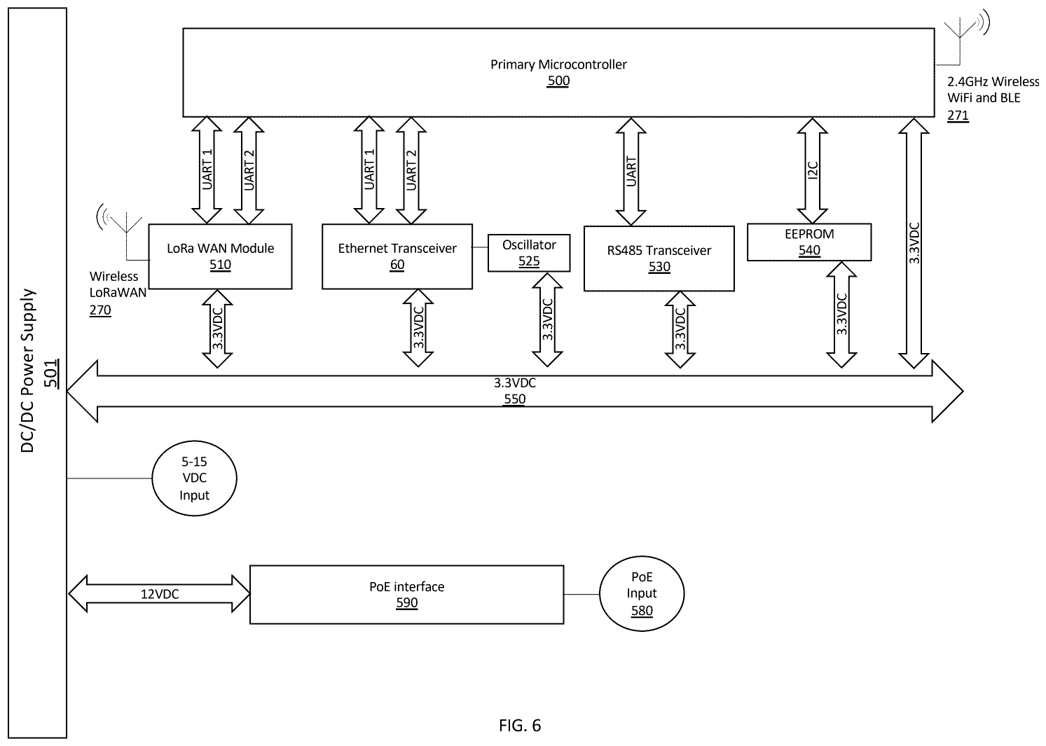

FIG. 1 shows various components of the MPA device 10. A processor 15 is coupled to storage 20 and uses both RAM and ROM memory 25. The processor 15 has an RS485 driver 70 that communicates over an RS485 interface 75. The processor 15 further has a communication system 30 which works with a Wi-Fi radio 40 coupled to a Wi-Fi antenna 45 as well as with a LoRa radio 50 coupled to a LoRaWAN antenna 55 and an ethernet phy 60 coupled to a physical ethernet port 65. Some of these devices may be integrated into the microcontroller 500 as shown in FIG. 6. It will be understood that the radio itself may be considered a LoRa module 50 and the overall device provides the logical LoRaWAN layer on top of the LoRa radio. In the example provided, the module used includes both the physical (radio) payer and the logical layer providing the LoRaWAN network connection and thus is referred to as a LoRaWAN module 510 as shown in FIG. 6. A DC power supply 80 connector or power over ethernet 85 via the ethernet connector 65 can power the processor and various components of the device.

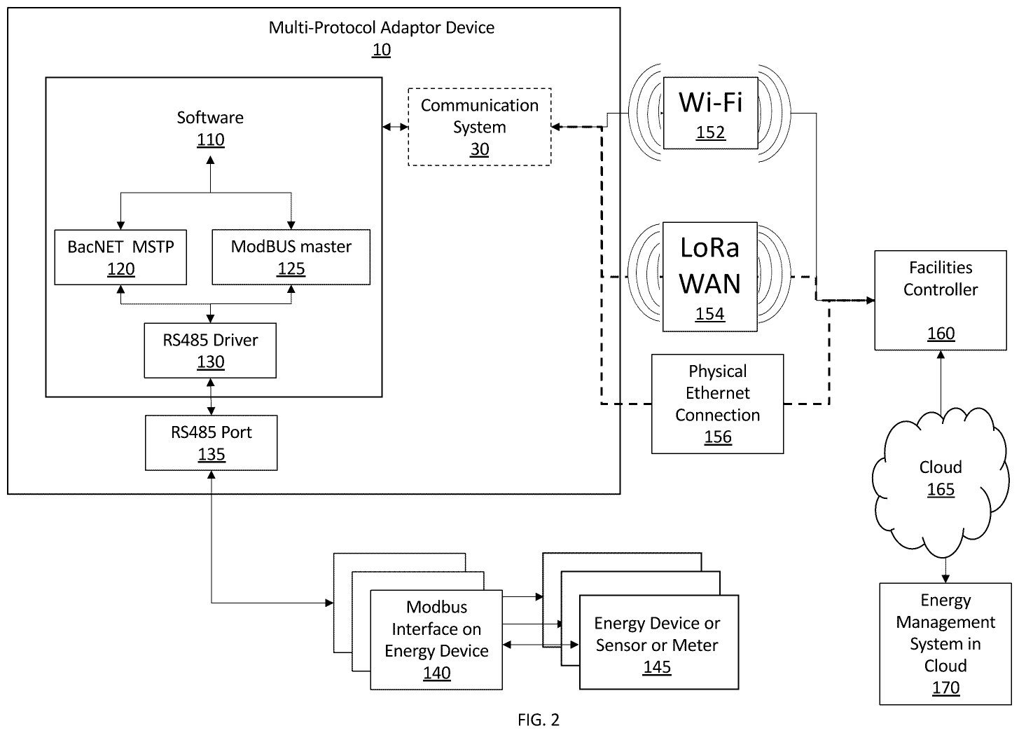

Turning now to FIG. 2 we see an application of the MPA device with its interaction with an external device and a management system in the cloud. The MPA device 10 has software 110 which executes on the processor 15 and the software 110 encompasses a BACnet multiple spanning tree protocol (MSTP) 120 and Modbus master 125 which communicate using an RS485 driver 130. Devices 145 are connected via their Modbus interfaces 140 to the RE485 port 135m, these devices may be a variety of environment conditioning devices such as HVAC devices including heat, air conditioning, ventilation as well as refrigeration devices and the like that are used to condition spaces by heating and cooling. This software and the components thereof may execute on the microcontroller 500 shown in FIG. 6.

The MPA device 10 software 110 also has a communication system 150 that can interface over Wi-Fi 152, LoRaWAN 154 or a physical ethernet connection 156 to a facilities controller 160. The Facilities controller communicates over the cloud 165 to a central energy management system 170.

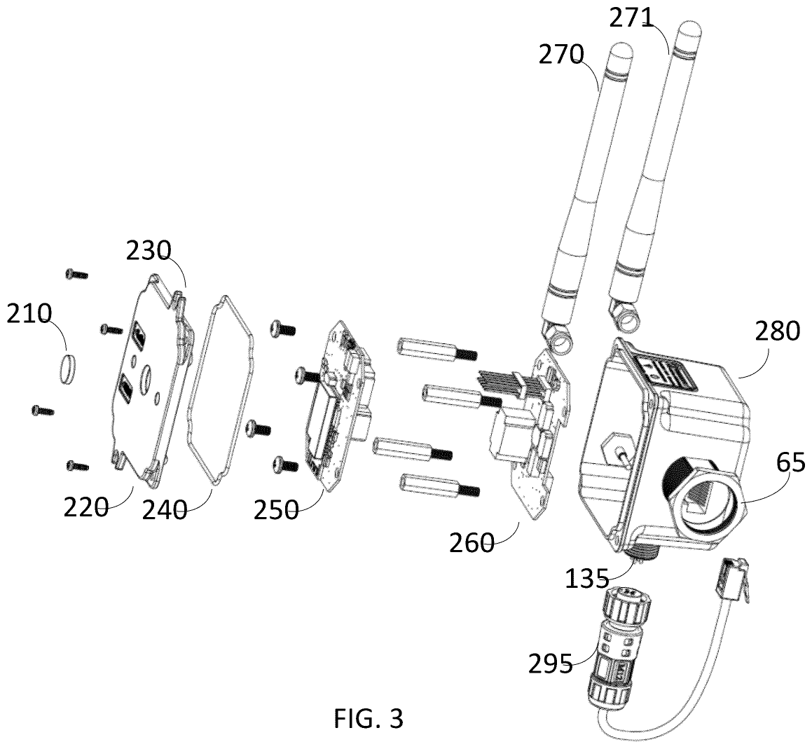

FIG. 3 shows an exploded view of the multi-protocol adaptor. The enclosure cover 220 has a magnetic mount 210 on a face of the MPA device. The cover is mounted with mounting lugs through mounting slots 230 to the control board 250. A gasket seal 240 is sandwiched between the cover 220 and the main housing 280 to protect the control board 250. The gasket provides a watertight seal for the enclosure 230/240/280. This control board 250 assembly is mounted to the power board 260 and then the whole assembly goes into an enclosure housing 280. LoRaWAN and Wi-Fi antennas 270 and 271 are attached on the side of the housing 280 and connected to the power and the circuit board(s) 250/260. As shown, a modbus cable 295 may be attached to the connector 135. The cable 295 may both supply power and have pin connectors for data interfacing. In other cases power over ethernet is used. An RJ-10 cable is depicted in the diagram however, this versatile connector can attach to various types of interfaces and may be simply open wires depending on the application. The connector 295 and port 135 incorporates pin connectors for 12 vdc, GND, RS485 A and RS485 B. If ethernet is used on the ethernet port 65 then PoE (power over ethernet) is used to power the device.

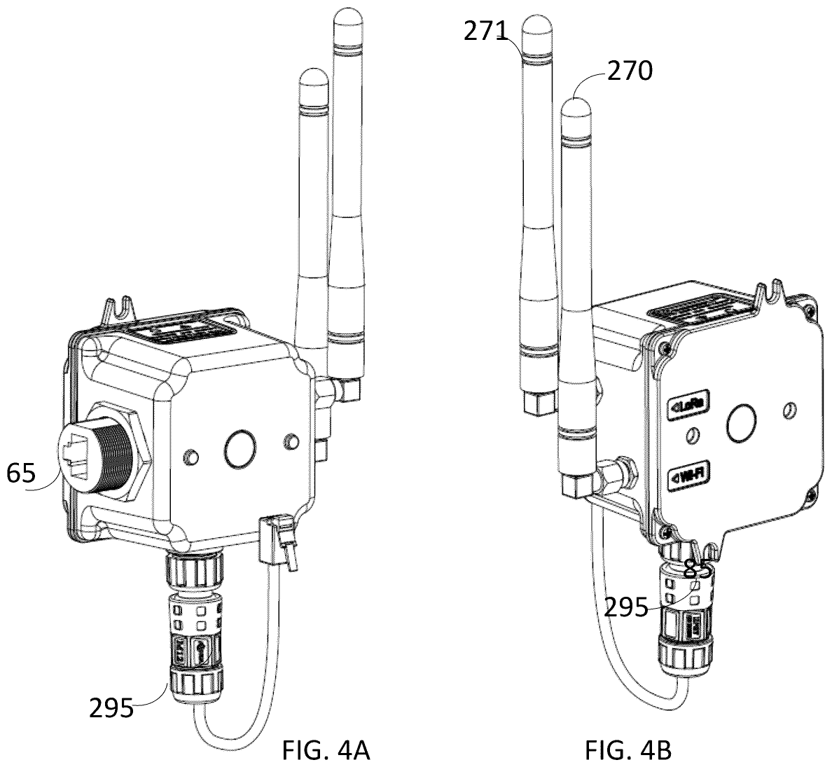

FIGS. 4A and 4B show front and rear perspective views of the same MPA device assembled. A magnet may also be provided on the rear cover as well to enable easy mounting of the adaptor. The ethernet connector 65 is shown as well as the weatherproof Modbus connector 295. The Wi-Fi and LoRaWAN antennas are shown as well.

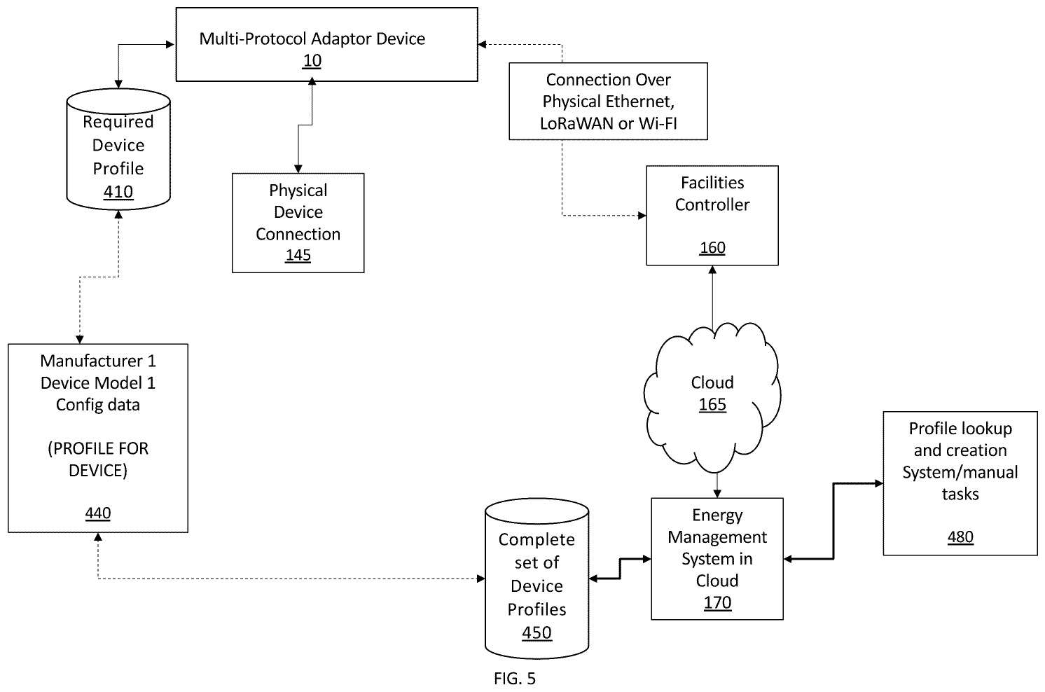

Turning now to FIG. 5, the Multi-Protocol Adaptor 10 device is physically connected to a target BACnet device 145. The MPA 10 communicates with a Facilities Controller 160 which is connected through the cloud 165 to an energy management system 170. This Energy management system 460 has a database of device profiles 450 that can be used to connect known BACnet devices 420 to the MPA 10. Additionally, a system of profile management 480 is present to allow users to add profiles or modify profiles stored in the database 450.

The MPA 10 receives the required device profile 440 containing the appropriate information for the physically connected device 145 and this profile is locally stored 410 on the device for communications with the device 420.

FIG. 6 shows a block diagram of the electronics used in the MPA multi-protocol device. The physical device may break the components shown up into e.g. two boards 250/260 as shown in the earlier figures or include different ones of the modules shown on the board(s) provided. There is a primary microcontroller 500 which may be found in one of the boards 250/260 or may be distributed across the two boards. The controller 500 is connected to a variety of modules including a LoRa module 510 an ethernet transceiver 60 which is in turn connected to an oscillator 525. The primary microcontroller is also connected to an RS485 transceiver 530, and EEPROM 540 for storage, and to the 3.3 VDC bus for power. The Microcontroller 500 also has a built in Wi-Fi and Bluetooth radios, for example. The microcontroller 500 is connected to for example 2.4 Ghz Wi-Fi and/or BLE antennas 271 while the LoRaWAN module 50 is connected to a Wireless LoRaWAN antenna 270. The LoRaWAN module 50 A DC/DC power supply 501 is shown as well as an alternate source of power via PoE 580 that connects to the supply with a PoE interface 590. The device can be powered via PoE (power over ethernet) or through an external power supply.

The enclosure is in preferred embodiments water resistant to enable mounting via the magnet or other means in external environments such as rooftops or outside where many HVAC devices or their components (especially compressors) are found. IP-2 or greater protection is provided, preferably IP-3 or better, IP-4 or better, IP-5 or better or most preferably IP-6 or better. These refer to: IP0: The outer structure does not protect against liquid. IP1: The outer structure prevents the ingress of droplets that fall directly on the top of the printer. IP2: The outer structure prevents the ingress of droplets that fall directly on the top of the printer as well as droplets that land at a 15° angle. IP3: The outer structure prevents the ingress of liquid from low-pressure sprays at 60° angles. IP4: The outer structure prevents the ingress of liquid from low-pressure splashes at all angles. IP5: The outer structure prevents the ingress of liquid from low-pressure jets at all angles. IP6: The outer structure prevents the ingress of liquid from high-pressure jets at all angles.

It will be understood by those of skill in the art that while examples using sensors and energy management devices are utilized in the disclosure, the same system can be adapted and used for other systems wishing to convert physical signals into wireless communication.

While the disclosure is susceptible to various modifications, and alternative forms, specific examples thereof have been shown in the drawings and are herein described in detail. Is should be understood however that the disclosure is not limited to the particular forms or methods or embodiments disclosed.

What is claimed is:

1. A device for sending and receiving data comprising:
an enclosure, the enclosure containing a plurality of communication devices, the plurality of communication devices comprising a long rage wide area network (LoRaWAN) device, an ethernet interface, a building and automation control network (BACnet) device, a Wi-Fi device;
a port comprising at least two pin connectors positioned on the enclosure and configured to allow an RS connector to connect to the port to thereby enable communications with the BACnet device;
an ethernet port configured to allow an ethernet connector to connect to the ethernet port to thereby enable communications with the ethernet interface;
an antenna for the LoRaWAN and/or the Wi-Fi device;
the device configured such that data received from any one of the plurality of communications devices is transmittable via any other one of the plurality of communications devices.

2. The device of claim 1 wherein the port provides for connection to an RS485 connection.

3. The device of claim 1 wherein the data is received over MQTT.

4. The device of claim 1 wherein the data is transmitted over MQTT.

5. The device of claim 1 wherein the enclosure is weather resistant.

6. The device of claim 1 wherein the data is received from the port and converted by the device to a wireless signal for transmission via one or more of the communications devices configured to transmit wirelessly.

7. The device of claim 1 wherein the antenna comprises at least two antennas, a first one of the at least two antennas is connected to the LoRaWAN device and a second one of the at least two antennas is connected to the Wi-Fi device.

8. The device of claim 1 wherein the port comprises at least four pin connectors, at least two of the pin connectors configured to receive power in order to power the communication devices and at least two of the pin connectors configured to receive data.

9. A device for sending and receiving data comprising:
an enclosure, the enclosure containing a controller, a memory and a plurality of communication devices, the plurality of communication devices comprising a first wireless communication device, a second wireless communication device, a first wired communication device and a second wired communication device;
the first wireless communication device configured to operate at a first frequency band;
the second wireless communication device configured to operate at a second frequency band which is different from the first frequency band;
a first antenna positioned outside the enclosure and configured to connect to first wireless communication device via a first connection which passes through the enclosure;
a second antenna positioned outside the enclosure and configured to connect to the second wireless communication device via a second connection which passes through the enclosure;
a first port and a second port, the first port associated with the first wired communication device and the second port associated with the second wired communication device and the controller is configured to receive power via the first or second port;
the device configured such that data received from any one of the plurality of communications devices is transmittable via any other one of the plurality of communications devices.

10. The device of claim 9 wherein the first wireless communication device is configured to communicate via LoRaWAN.

11. The device of claim 9 wherein the second wireless communication device is configured to communicate via Wi-Fi.

12. The device of claim 10 wherein the second wireless communication device is configured to communicate via Wi-Fi and the first wired communication device is configured to communicate with a BACnet network and the second wired communication device is configured to communicate via ethernet.

13. The device of claim 9 wherein the enclosure is weather resistant.

14. A method of connecting a environment conditioning device to a network comprising:
connecting an adaptor to a physical communication port of an environmental conditioning device at a facility
transferring data between the environmental conditioning device and a first computer via the adaptor, the adaptor comprising an enclosure, the enclosure containing a controller, a memory and a plurality of communication devices, the plurality of communication devices comprising a first wireless communication device, a second wireless communication device, a first wired communication device and a second wired communication device;
wherein the physical communication port is associated with the first or second wired communication device and the data is transferred between the environmental conditioning device and the first computer via the adaptor using one of: the first wireless communication device, the second wireless communication device or one of the first or second wired communication device which is not associated with the physical communication port.

15. The method of claim 14 wherein the first wireless communication device is configured to operate at a first frequency band and the second wireless communication device is configured to operate at a second frequency band which is different from the first frequency band.

16. The method of claim 14 further comprising:
a first antenna positioned outside the enclosure and configured to connect to the first wireless communication device via a first connection which passes through the enclosure;
a second antenna positioned outside the enclosure and configured to connect to the second wireless communication device via a second connection which passes through the enclosure.

17. The method of claim 14 wherein the data is transferred to the first computer using the first wireless communication device and the first wireless communication device communicates via a long rage wide area network (LoRaWAN).

18. The method of claim 17 wherein the physical communication port comprises at least two pin connectors.

19. The method claim 14 wherein the data is transferred to the first computer using the second wired communication device and the second wired communication device comprises an ethernet connection.

20. The method of claim 14 wherein connecting the adaptor to the physical communication port of the environmental conditioning device at the facility comprises connecting each of a plurality of adaptors to one of a plurality of the environment conditioning devices via the physical communication port of the associated environmental conditioning device and wherein transferring data between the environmental conditioning device and the first computer comprises transferring the data between the plurality of environmental conditioning devices to the first computer via the associated one of the plurality of adaptors.
